(19) United States
(12) Patent Application Publication
(10) Pub. No.: US 2016/0158088 A1
(43) Pub. Date: Jun. 9, 2016

(54) Suspension-Based Walking Assistance Aide Apparatus

(71) Applicant: Justin Frankian, Woodland Hills, CA (US)

(72) Inventor: Justin Frankian, Woodland Hills, CA (US)

(21) Appl. No.: 15/019,757

(22) Filed: Feb. 9, 2016

Related U.S. Application Data
(63) Continuation-in-part of application No. 14/791,512, filed on Jul. 6, 2015.
(60) Provisional application No. 62/021,408, filed on Jul. 7, 2014.

(51) Int. Cl. A61H 3/04; A61H 3/00

(52) U.S. Cl. CPC A61H 3/04; A61H 3/008

(57) ABSTRACT

A walking assistance device configured to permit the independent movement of an individual via simulated weight reduction is described. The device is configured to partially suspend a portion of a user's weight via a suspension system, facilitating the movement of a user with experiencing difficulty walking without assistance. The suspension system of the device preferably employs at least one cable in communication with a pulley system, an electric lifting actuator, and a harness. The harness of the device is configured to affix to the legs and torso of the user, and connects to at least one cable of the pulley system via at least one hook. The lifting actuator engages the pulley system, enabling the user to control the percentage of weight lifted. A frame houses the suspension system of the device, and is configured to move laterally via wheels on the bottom of the frame of the device.

### CONTINUITY

This application is a Continuation-in-Part of non-provisional application Ser. No. 14/791,512, filed on Jul. 6, 2015, which claims the benefit of provisional patent application No. 62/021,408, filed on Jul. 7, 2014, and priority is claimed thereto.

### FIELD OF THE PRESENT INVENTION

The present invention pertains to walkers and similar walking assistance devices, and more specifically relates to a walking assistance device configured to permit the independent movement of the individual with minimal or decreased use of the user's hands or legs for support of the user.

### BACKGROUND OF THE PRESENT INVENTION

In the past, the majority of walkers have been used for aiding elderly, ambulatory patients in walking, whether in nursing homes, hospitals, rehabilitation centers, or in their own homes. Traditionally, these walkers consisted of a four-legged frame with front brace. Often, the two rear legs would be capped with spherical, soft accessories (i.e. tennis balls) to inhibit spontaneous, erratic movements and slippage.

Prior art allowed for support for elderly patients with compromised use of their lower extremities to hold themselves up with the walker. It also required significant strength in the patient's arms and upper body to lean on the walker to assist their legs. However, prior art failed to provide a means of movement for patients with very limited use of the lower extremities and an inability to balance and hold their upper torso upright Similar devices have been created for use by children, also known as child walkers. These walkers are conventionally configured with a seat that holds the child at distance from the ground, whereas the child's legs would dangle below, in contact with the ground. At the bottom, a frame with multiple wheels aids in the movement of the child, for which the child provided propulsion through the use of the legs. The purpose and function of these devices were to prevent a child from falling while learning to walk.

Prior art known to the field has also failed in providing a means of holding up the upper torso of the user's body and allowing users with disabilities in the lower extremities to propel themselves manually. Some prior art attempted to solve the problem of aiding patients with limited faculty in the lower extremities by providing an external source of power (i.e. motorized wheels) that would propel the patient horizontally, however this ignored any potential rehabilitative, therapeutic effects by leaving the patient out of the propulsion process.

Furthermore, prior art also provided a means of supporting the patient's upper torso through use of a height adjustable hoist, however failed to address facilitating the patient's input and/or making it easier for providing horizontal propulsion via the lower extremities for patients. All prior art required that the users full weight be supported by the strength of his or her legs and/or partially supported with the strength of the arms.

Thus, there is a need for a new walker aide device configured to assist the user in moving without the need for his or her weight to be completely supported by the strength of the legs of the individual or the arms of the individual.

### SUMMARY OF THE PRESENT INVENTION

The present invention is a walking assistance device configured to aide an individual in independent movement. The device is configured to partially suspend a portion of the weight of the user to make it easier for the user to support his or herself while moving.

The present invention overcomes the debilitating effects of a wheelchair for a majority of patients who rely on wheels to move around. It also minimizes the risk of falling for those who rely on walking aids such as canes and walkers, within the limitations of the terrain.

The present invention consists of a four-legged frame, with omnidirectional wheels situated at the bottom of each leg. A linear actuator with a hook mounted on a rear tubing behind the patient and is connected to an adjustable harness system in some embodiments of the present invention. In the preferred embodiment of the present invention, the rear hook is connected to a lifting mechanism via a cable. The patient is placed in the harness system, to which the actuator/lifting mechanism can add varying degrees of tension to reduce the weight of the patient as needed according to their condition and strength. This reduction in weight would allow the patient to implement the use of the legs and feet to propel him or herself vertically and/or horizontally with respect to the floor as the plane of movement with less force than would usually be required to move along if the full weight were placed on the lower extremities

### BRIEF DESCRIPTION OF THE DRAWINGS

The present invention will be better understood with reference to the appended drawing sheets, wherein:

FIG. 1 displays a front perspective view of the preferred embodiment of the present invention as seen from the side, detailing the profile of the present invention.

FIG. 2 shows a view of an alternate embodiment of the present invention, showing the harness integrally attached to the actuator of the present invention.

FIG. 3 exhibits a front view of a second alternate embodiment of the present invention, having a lower profile, larger wheels, and improved brakes.

FIG. 4 displays a side view of the second alternate embodiment of the present invention.

### DETAILED DESCRIPTION OF THE PREFERRED EMBODIMENT

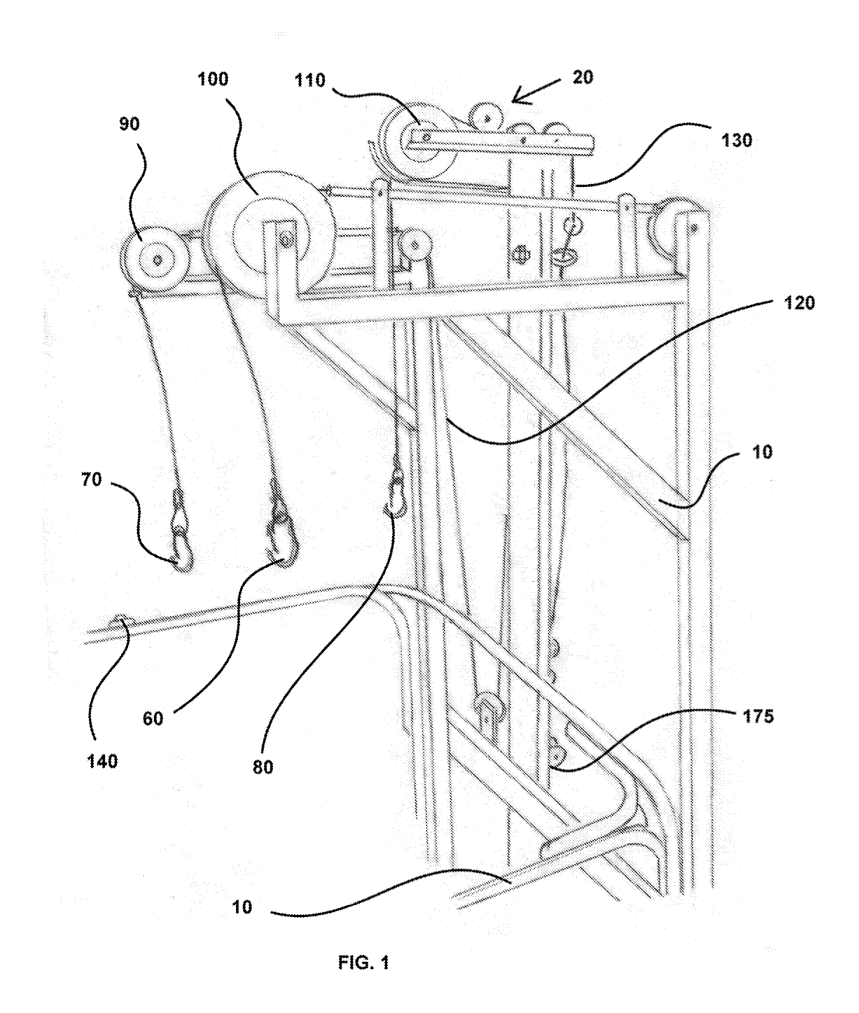

The present invention generally comprises a frame (10), a pulley system (20) a harness (30), padding (40), wheels (35), and a lifting actuator (175) with an integrated motor. The padding (40) of the present invention is preferably integrated into the harness (30). The harness (30) of the present invention is preferably equipped with a first front hook (60), a second front hook (70), and a rear hook (80). The first front hook (60), second front hook (70) and rear hook (80) may be present on the cabling rather than the harness (30) of the present invention, as shown in FIG. 1. During use of the present invention, the lifting power is conveyed to the harness (30) through cables connected to the first front hook (60), second front hook (70, and rear hook (80) to lift the patient as desired by distributing the lifting power to each hook independently as needed. The pulley system (20) preferably consists of three pulleys: a right pulley (90), a left pulley (100), and a center pulley (110) configured to route the cables from the harness (30) to the lifting actuator (175).

The left pulley (100) and the right pulley (90) are configured to evenly distribute the weight of the user so as to ensure that the user remains relatively level when suspended by the frame (10) of the present invention. A first cable (120) is configured to extend from the lifting actuator (175) to the left pulley (100), and secured to the harness (30) with the first front hook (60) at a loop on the front of the harness (30). A second cable (130) is configured to extend from the lifting actuator (175) to the center pulley (110), and to the rear hook (80). Lastly, a third cable (140) is configured to extend from the lifting actuator (175) to the right pulley (90), and down to the second front hook (70). The rear hook (80) connects to a center pulley via a center cable. To release, the motor or lifting actuator (175) deactivates, and slowly releases the harness from suspension. A switch (140) is preferably disposed on the right portion of the frame, and is easily accessible by the right hand of the user.

The user is preferably partially suspended by the present invention in this manner for a variety of reasons. The second cable (130) affixed to the rear hook (80) is configured to lifts slightly more weight than that of the first cable (120) and the third cable (140), to better assist those with poor back conditions. For example if a patient has spinal sclerosis, or spinal stenosis, degenerative spine disease, herniated disc, sciatica, musculoskeletal problems, weekend lower extremities muscles due to poor blood circulation, or neurological conditions like ALS, the second cable (130) should be configured to lift the patient more from the rear center of the patient, rather than the sides. These and other conditions may require more lifting and support from the upper half of the body, in which case a single harness attached to the chest area, lifting from the upper back and under the arms; or, a two piece harness that can lift independently may be employed. Such a harness (30) is configured to supply more suspension strength to the center of the body, as conveyed via the motor within the lifting actuator (175) and held in the desired position via the brake assemblies (170). The suspension strength of the system of the present invention is therefore applied in the upper part of the body, rather than the lower trunk.

Various embodiments of invention are now described in more detail with reference to the accompanying figures and drawings, where some but not all embodiments of invention are displayed and/or illustrated in the figures. As expected, these inventions may be consolidated into many different forms and should not be interpreted as limited to the embodiments set forth herein; these embodiments are made available so that this disclosure will fulfill relevant legal requirements.

FIG. 1 portrays one embodiment of the invention. The frame (10) of the present invention preferably consists of steel and/or aluminum tubing, running horizontally and vertically and forward/backward (similar to that of a conventional walker), provides the structural foundation for housing other devices of the invention and for supporting the weight and balance of the patient. These tubings may be continuous, bent forms and/or different pieces welded and/or bolted together. A 12 volt DC battery (150) is preferably situated on the bottommost horizontal tubing (though may be located on any part of the frame (10) where convenient and not in opposition to the function of the device), with an electrical harness (155) that connects the battery (150) to an adjustable actuator connecting power to the brake assembly (170) via electric cables (165).

The brake assembly (170) is most commonly in the locked or ‘on’ state, ensuring that the user remains in the desired position in height (via percentage of weight suspended) and placement during motion while using the present invention. Four omni-directional casters (55), having free rotation about their vertical axes, are each situated at one of the four legs of the frame (10), and are configured to house the wheels (35) of the present invention. If need be, additional casters (55) may be added to provide more stability, or may conversely be reduced to three casters to allow for a triangular formation of the frame (10) and the wheels (35). On the bottommost tubings, a pair of brake assemblies (170) are housed, one disposed on each the right side and the left side of the frame (10). Additional brake assemblies (170) assemblies may be provided, or just one assembly, contingent on the stability the patient requires.

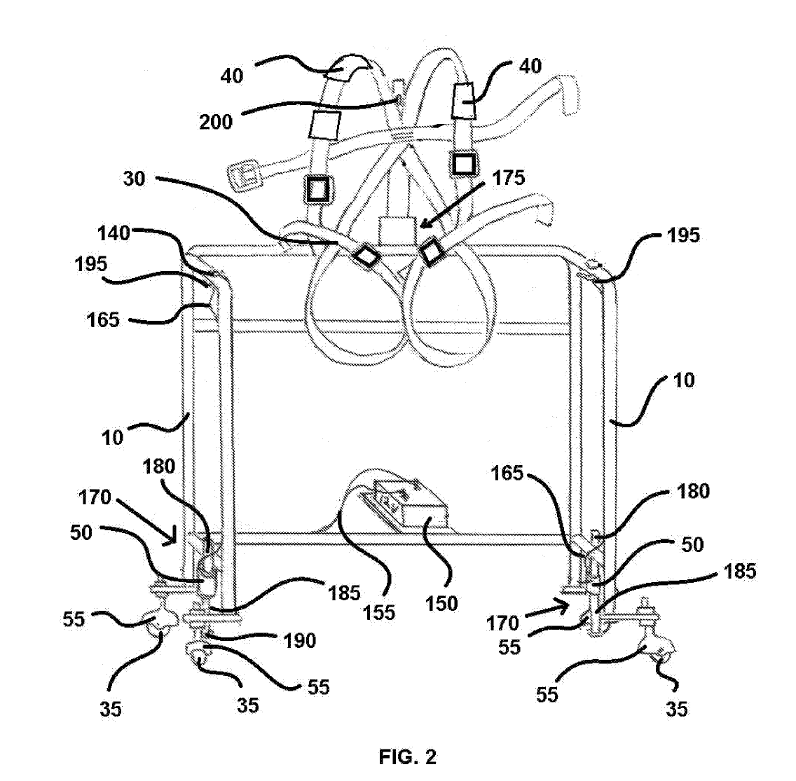

FIG. 2 displays the individual components of the brake assembly (170). Each assembly consists of a brake actuator (50) connected to a shaft (180). The shaft (180) is linked to a horizontal bar that has two legs (185); each have a non-skid brake pad (190) adhered to the bottom.

The brake pads (190) are configured to move up and down into contact with the floor when the actuators are activated. The pads' function is to prevent slipping and unwanted forward/rearward/sideward (planar) movement when the user is at rest. The use of the assembly is preferably controlled by the brake switch release handles (195). Either handle can release the normally-on brakes, thus activating the brake actuator (50) to lift the brake pads (190) off the floor. Therefore, the brake pads (190) are normally in contact with the floor so the user can maintain stability during use of the present invention.

Once the user desires to move, then the brake switch release handles (195) can be activated to lift the brake pads (190) off the floor. The brake assemblies (170) need not be controlled by release handles (195) in all embodiments of the present invention, but can also be activated through the use of buttons, capacitive touch sensors, micro-controllers, or any sort of mechanism that would allow a patient with limited use of the hands to easily manipulate the current to the brake assembly (170). The brake assemblies (170) are connected to the battery (150) through the electrical harness (155) with the brake release electrical cables (165). The electrical cables (165) consist of wiring that runs along the vertical tubings of the frame (10), from where the brake switch release handles (195) are situated. The primary function of the invention lies in the weight-reducing adjustable actuator (175), which is fastened to a brace that is welded to the top, rear horizontal tubing of the frame (10), and is powered by the battery (150) through the electrical harness (155). A harness lift hook (200) is connected to the end of the actuator rod, which is configured to attach to the rear hook (80). The hook connects to the ring in the adjustable strap harness (30) via the rear hook (80). The user wears the strap harness (30), which is then connected to the actuator (175) through the harness lift hook (200).

FIG. 2 demonstrates a front view of the invention with the harness (30) situated on the harness lift hook (200). The lifting actuator (175) is activated to lift the patient as desired, and reduce his/her weight off the ground. Therefore, with less weight on his/her feet, the patient can concentrate on using his/her legs to propel himself/herself horizontally with the aid of the structure, tracking across the floor surface with the casters, requiring less effort and pain. The lifting actuator (175) relieves the weight from the patient, and transfers it to the floor through the structure of the frame (10). As a result, patients who are semi-mobile, disabled, and/or weak in the lower extremities would be able to use minimal strength in exercises such as gait training and would be able to mimic the effects of water therapy, however in a non-aqueous environment, i.e. the surface, all without the need for strength from the upper body and arms. The invention overcomes the debilitating effects of a wheelchair for a majority of patients who rely on wheelchairs or wheeled walkers to move around. Use of the present invention also minimizes the risk of falling for those who rely on walking aids such as canes and walkers, within the limitations of the terrain.

Alternate embodiments of the present invention may include variations on the frame (10), wheels (35), and brake switch release handles (195). For example, push handles may be disposed at the rear of the tubing of the frame (10) to facilitate pushing a user in the device of the present invention by a nurse or assistant from the rear, similar to a wheelchair. This can be helpful for expediting the training process of use for a user of the present invention. Additionally, an electric, motorized wheel may be included in some embodiments of the present invention to facilitate use of the present invention as an extra mobility option if needed.

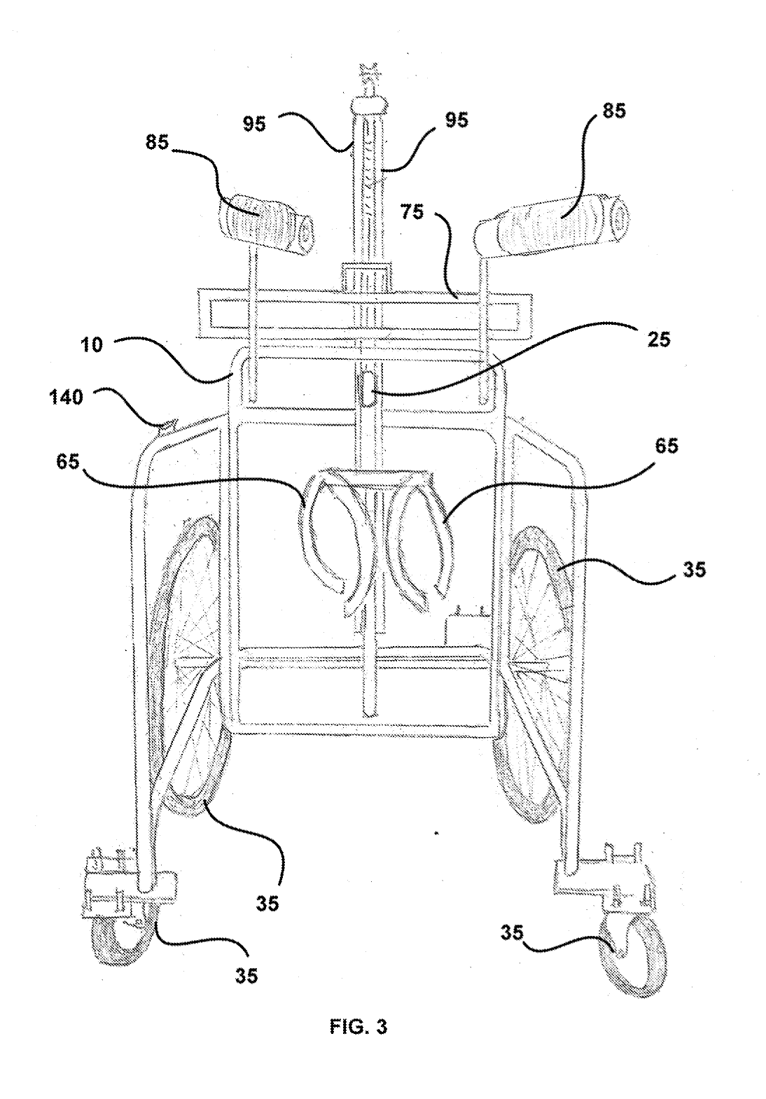

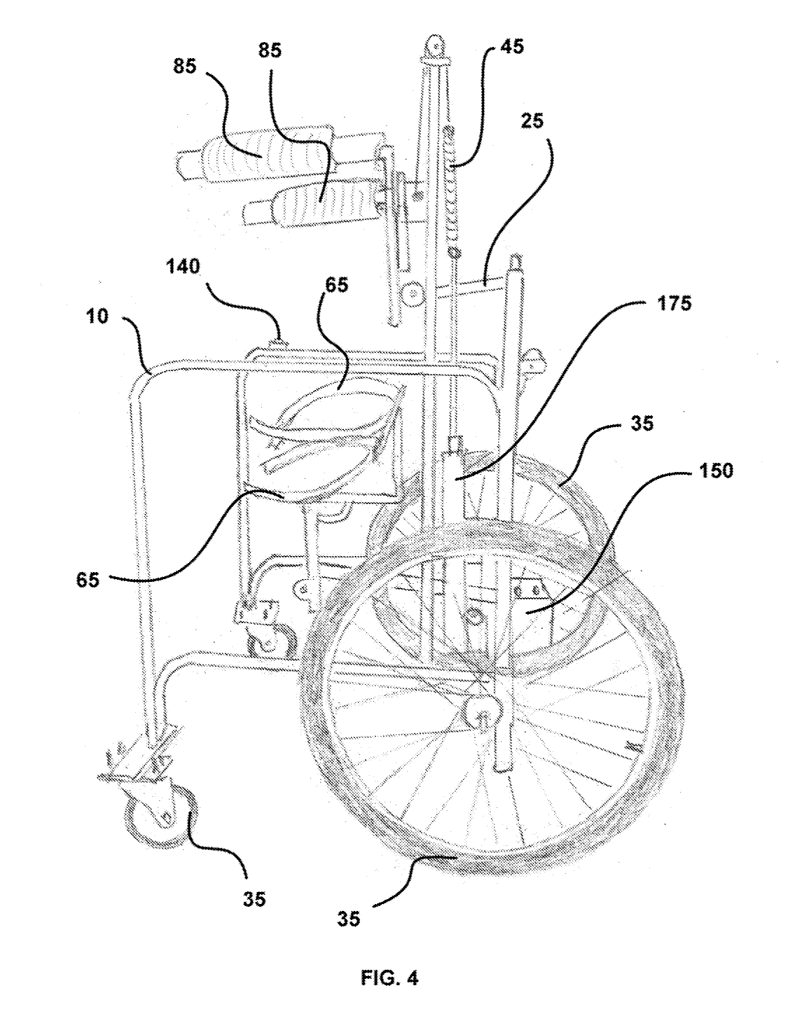

Such alternate preferred embodiments of the present invention are best embodied in FIG. 3 and FIG. 4. An alternate lower preferred embodiment of the present invention is shown in FIG. 3 that includes larger wheels, an improved braking system, and employs a leg harness lifting system in lieu of the pulley system. In these preferred alternate embodiments, bicycle-style brakes are employed on the wheels (35) to provide optimal stopping power and better control than the braking system disclosed in FIG. 1 and FIG. 2. Similarly, as evidenced in FIG. 3 and FIG. 4, the wheels (35) of the rear have been replaced with 24 inch bicycle wheels which provide for easy maneuvering of the present invention during use. Additionally, the height of the frame (10) is approximately six inches shorter than the embodiments shown in FIG. 1 and FIG. 2, facilitating a more ergonomic handgrip. The frame (10) is similarly supported by four wheels (35) in a configuration that provides a narrower wheelbase and greater stability that other embodiments of the present invention. The alternate embodiment disclosed in FIG. 3 and FIG. 4 remains true to its original purpose and idea of the present invention, as well as the method of accomplishing its goal. Namely, this goal is to assist patients with limited strength in their lower extremities to be able to stand upright and walk, with little or no assistance, depending on their physical condition and strength. The use of the upper harness remains optional for the users who have balance, and sufficient strength in their lower extremities. The harness (30) of this embodiment of the present invention is attached directly to the lifting actuator (175), which eliminates the need for the cables and additional pulleys to facilitate use of the present invention.

Other components of the alternate preferred embodiment of the present invention shown in FIG. 3 and FIG. 4 include lifting rods (95), underarm support crutches (85), thigh straps (65) for use in lieu of (or in addition to) the harness (30), an upper body lifting mechanism (75). a tension spring (45), and a stabilizer bracket wheel (25). The underarm support crutches (75) and thigh straps (65) function together to suspend a portion of the user's weight via engagement of the lifting actuator (175) via the switch (140). The tension spring (45) is configured to enable the user to adjust the ratio between the upper body lifting tension (the tension supplied to the underarm support crutches (85) and/or harness (35)) and the lower body lifting tension (supplied via the thigh straps (65)).

All embodiments of the present invention preferably employ a 12 volt D.C. winch motor as a lifting actuator (175), powering the suspension portion of the present invention. The 12 volt D.C. winch motor is preferably configured to only control a single cable. The single cable is preferably routed through the pulley system (20) of the present invention such that the proper amount of lifting power is distributed evenly to each of the three cables. In the alternate preferred embodiment shown in FIG. 3 and FIG. 4, the lifting actuator supplies lifting tension to the thigh straps (65) and to the underarm support crutches (86) directly via a single cable, chain, or similar line, and employs the tension spring (45) for adjustment.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A weight suspension and motion device for a user walking comprising:
a harness;
a frame;
wherein said harness is configured to extend around a torso of the user; and
wherein said harness is temporarily suspended from said frame, partially supporting the weight of the user.

2. The device of claim 1, further comprising:
a pulley system equipped with at least one pulley;
a lifting actuator, said lifting actuator affixed to said frame;
a power supply, said power supply in communication with said lifting actuator via electrical cables;
at least one cable, said at least one cable affixed to said pulley system;
wherein said harness is in communication with said frame via said at least one cable; and
a switch, said switch configured to activate said lifting actuator to lift said harness via said at least one cable, partially suspending the weight of the user, reducing the weight supported by limbs of the user.

3. The device of claim 1, further comprising:
wheels, wherein said wheels are affixed to casters;
wherein said wheels are configured to lock;
wherein said casters are in communication with said frame;
at least one brake assembly;
at least one brake pad;
a brake actuator; and
wherein said brake actuator is in communication with said power supply via said electrical cables.

4. The device of claim 3, further comprising:
brake switch release handles;
wherein said brake switch release handles are in communication with said brake actuator; and
wherein said brake switch release handles are disposed on said frame.

5. The device of claim 1, wherein said at least one cable is a braided metal cable.

6. The device of claim 1, wherein said harness is configured to strap to the legs and shoulders of the user.

7. The device of claim 3, wherein said brake switch release handles are configured to release the brake actuator when squeezed, permitting movement of the wheels.

8. The device of claim 3, further comprising:
a pulley system equipped with at least one pulley;
a lifting actuator, said lifting actuator affixed to said frame;
a power supply, said power supply in communication with said lifting actuator via electrical cables;
at least one cable, said at least one cable affixed to said pulley system;
wherein said harness is in communication with said frame via said at least one cable; and
a switch, said switch configured to activate said lifting actuator to lift said harness via said at least one cable, partially suspending the weight of the user, reducing the weight supported by limbs of the user.

9. The device of claim 2, further comprising:
wheels, wherein said wheels are affixed to casters;
wherein said wheels are configured to lock;
wherein said casters are in communication with said frame;
at least one brake assembly;
at least one brake pad;
a brake actuator; and
wherein said brake actuator is in communication with said power supply via said electrical cables.

10. The device of claim 4, further comprising:
a pulley system equipped with at least one pulley;
a lifting actuator, said lifting actuator affixed to said frame;
a power supply, said power supply in communication with said lifting actuator via electrical cables;
at least one cable, said at least one cable affixed to said pulley system;
wherein said harness is in communication with said frame via said at least one cable; and
a switch, said switch configured to activate said lifting actuator to lift said harness via said at least one cable, partially suspending the weight of the user, reducing the weight supported by limbs of the user.

11. The device of claim 9, wherein said harness is configured to strap to the legs and shoulders of the user.

12. The device of claim 10, wherein said harness is configured to strap to the legs and shoulders of the user.

13. A method for walking with assistance due to a reduced body weight via suspension comprising:
strapping a harness to a user's legs and shoulders;
affixing the harness to a harness lift hook;
wherein said harness lift hook is in communication with at least one suspension cable;
wherein said at least one suspension cable is disposed in a pulley system;
affixing a first end of said at least one suspension cable to said harness lift hook;
affixing a second end of said at least one suspension cable to a lifting actuator;
powering the lifting actuator with a battery;
the lifting actuator lifting a portion of the weight of the user, effectively reducing the weight of the user;
the user depressing at least one brake switch handle; and
the user walking easier with less strain exerted by the legs of the user to support the weight of the user.

14. The method of claim 13, wherein said lifting actuator is a motorized winch.

15. The device of claim 4, wherein said brake pad and said brake assembly are configured to clamp to an exterior surface of the wheels to facilitate a stop.

16. The device of claim 4, wherein two instances of said wheels are bicycle wheels.
